(19) United States
(12) Patent Application Publication
(10) Pub. No.: US 2025/0286770 A1
(43) Pub. Date: Sep. 11, 2025

(54) NETWORK FAULT DETECTION USING A MACHINE LEARNING MODEL

(71) Applicant: HEWLETT PACKARD ENTERPRISE DEVELOPMENT LP, Spring, TX (US)

(72) Inventors: Gopal Gupta, Bangalore (IN); Isaac Theogaraj, Bangalore (IN)

(21) Appl. No.: 18/661,928

(22) Filed: May 13, 2024

(30) Foreign Application Priority Data
Mar. 8, 2024 (IN) 202441016990

(51) Int. Cl. H04L 41/0604; H04L 41/0631; H04L 41/16

(52) U.S. Cl. CPC H04L 41/0613; H04L 41/0631; H04L 41/16

(57) ABSTRACT

In some examples, a system receives a first representation of attributes associated with a network stack connected to an underlay network that couples a first system to a computing environment, where the network stack comprises a plurality of layers. The system receives a second representation of attributes associated with an overlay network provided over the underlay network. The system provides the first representation and the second representation to a machine learning model trained to detect a fault associated with communications between the first system and the computing environment. The machine learning model generates an output comprising a value representing a likelihood of a presence of the fault associated with the overlay layer or the underlay layer. Based on the output, the system initiates a remediation action to address the fault.

### BACKGROUND

An electronic device can access a service of a computing environment. The electronic device may be at a remote location relative to the computing environment, and the electronic device may connect through a network device and over a network to the computing environment.

### BRIEF DESCRIPTION OF THE DRAWINGS

Some implementations of the present disclosure are described with respect to the following figures.

FIG. 1 is a block diagram of an arrangement that includes branch computing location coupled by an overlay and underlay network to a computing environment, according to some examples.

FIG. 2 is a block diagram of a neural network for predicting network faults, according to some examples.

FIG. 3 is a block diagram of an arrangement that includes a fault detection machine learning model, a fault processing engine, and a post-processor, according to some examples.

FIG. 4 is a block diagram of a storage medium storing machine-readable instructions according to some examples.

FIG. 5 is a block diagram of a system according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A remote location at which electronic devices are located may include a network device to communicate over network paths to a computing environment, such as a data center, a cloud computing environment, or any other type of computing environment. The computing environment includes resources that can provide one or more services accessible by electronic devices at remote locations. Examples of resources of the computing environment include programs, such as application programs or other types of programs (containing machine-readable instructions). Resources can also include hardware resources, such as processing resources, storage resources, communication resources, virtual resources, or other types of resources.

In some examples, a remote location may be coupled to the computing environment over a network arrangement that includes an overlay network and an underlay network (collectively referred to as an “overlay and underlay network”). The underlay network includes a network infrastructure (physical or virtual) over which the overlay network is provided. The underlay network may include multiple network paths (referred to as “uplinks”) to the computing environment. One of the uplinks may be selected for communications of a given electronic device. The overlay network provided over the underlay network can include tunnels according to a security protocol to support secure communications through the overlay network.

A fault may occur during a session established by an electronic device with a service of the computing environment over the overlay and underlay network. For example, the electronic device may be engaged in a call (e.g., an audio call or video conference call, such as a voice-over-IP (Internet Protocol) call) over the overlay and underlay network. During the session, the fault may cause an interruption in communications or otherwise disrupt operations associated with the service that is being accessed by electronic device. Once the fault occurs, an entity (e.g., a user, a program, or a physical component) associated with the electronic device may attempt to re-establish the session, which may take some time. During the interruption and subsequent attempt to re-establish the session, the service of the computing environment is inaccessible. The service interruption caused by the fault can lead to user inconvenience and degraded operations in the computing environment or at the electronic device.

In accordance with some implementations of the present disclosure, a machine learning model such as a neural network is used to produce an output that indicates a likelihood of a fault in network communications (referred to as “communication-related faults”) with a computing environment. The output from the machine learning model includes values representing likelihoods that an application layer or different layers of the overlay and underlay network caused the fault. An “application layer” can refer to a layer in which services are provided by programs or other resources of the computing environment. The layers of the underlay network include layer 2 (L2), such as a Media Access Control (MAC) layer; layer 3 (L3), such as an IP layer; and layer 4 (L4), such as a Transmission Control Protocol (TCP) layer, a User Datagram Protocol (UDP) layer, or another L4 layer. The layers of the overlay network include a route layer including routes (e.g., IP routes); a security protocol layer including tunnels (e.g., Internet Protocol Security or IPsec tunnels); and layer 4, such as a TCP layer, a UDP layer, or another L4 layer. The machine learning model receives representations of attributes of an application layer, the underlay network, and the overlay network. Based on the representations of attributes of an application layer, the underlay network, and the overlay network, the machine learning model provides indications of communication-related faults and which layers (the application layer or layers of the underlay network or overlay network) likely contributed to the communication-related faults. To reduce the dimensionality of the attributes considered by the machine learning model, the representations of the attributes can include embedding representations such as embedding vectors.

An “embedding” can refer to data points in a relatively low-dimensional space derived from a relatively high-dimensional representation of values. A “dimension” can refer to an attribute, such as a metric, a characteristic, or any other property. For example, resources such as application programs, underlay networks, and overlay networks may be associated with a relatively large quantity of attributes, and thus are represented by high-dimensional representations of values. An embedding thus encodes relevant information about original data in a lower-dimensional space. For use by a machine learning model, an embedding that has lower dimensionality is created, and the embedding is provided as an input to the machine learning model. An embedding vector can refer to a collection of data points derived from the high-dimensional representations of values. More generally, an “embedding representation” can refer to any representation containing an N-dimensional collection of data points (N>1) where N is less than the quantity of dimensions present in a high-dimensional representation of values. The data points in N-dimensional space of an embedding representation are arranged so that similar data points cluster together.

Using techniques or mechanisms according to some implementations of the present disclosure, faults associated with access of services over an overlay and underlay network can be predicted (sometimes before the faults even occur) so that entities can take remediation actions to prevent or reduce the likelihood that the faults will lead to service interruptions. Techniques or mechanisms according to some implementations improve the relevant technology and computer functionality of network communications and provisioning of computing services, by being able to perform an early determination that faults may occur. By using a fault detection machine learning model to predict faults, tedious and slow human analysis does not have to be performed. Also, the ability to predict faults allows the initiation of remediation actions to prevent the faults from actually occurring.

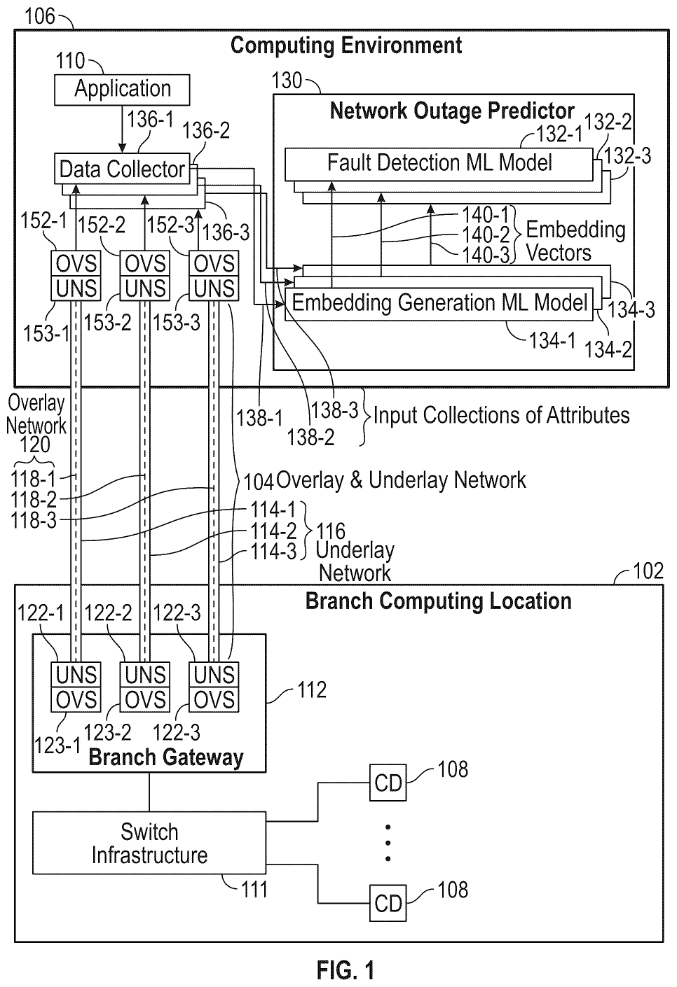

FIG. 1 is a block diagram of an example arrangement that includes a branch computing location 102 coupled over an overlay and underlay network 104 to a computing environment 106. The branch computing location 102 is an example of a computing location that is remotely located from the computing environment 106.

The branch computing location 102 includes client devices 108 that are able to access services of the computing environment 106. The services of the computing environment 106 can include a service provided by an application program 110, or provided by other resources of the computing environment 106. Examples of client devices can include any or some combination of the following: computers (e.g., desktop computers, notebook computers, server computers, tablet computers, etc.), smartphones, game appliances, vehicles, household appliances, Internet of Things (IoT) devices, or other types of electronic devices.

The client devices 108 can be coupled to a switch infrastructure 111 that includes one or more switches. A switch refers to a network device that forwards data packets along communication paths based on network addresses, such as Media Access Control (MAC) addresses in the data packets. A data packet can refer to any unit of data that can be separately transmitted in a communication path. The client devices 108 can include wired client devices and/or wireless client devices. A wireless client device can be wirelessly connected to access points (APs), which in turn are connected to the switch infrastructure 111.

The switch infrastructure 111 is connected to a branch gateway 112. A branch gateway is a type of edge router that can be coupled over multiple network paths, such as network paths of the overlay and underlay network 104, to the computing environment 106.

The branch gateway 112 can be part of a software-defined wide area network (SD-WAN) for managing which uplink paths to use for data communications between client devices and the computing environment 106. In such examples, the branch computing location 102 can be referred to as a branch office of the SD-WAN.

Although just one branch gateway 112 and switch infrastructure 111 are depicted in FIG. 1, in other examples, the branch computing location 102 can include multiple branch gateways and/or multiple switch infrastructures. Also, there may be multiple branch computing locations coupled to the computing environment 106 over respective overlay and underlay networks.

The overlay and underlay network 104 includes an underlay network 116 that has underlay uplink paths 114-1, 114-2, and 114-3. An “underlay uplink path” can refer to a path between the branch gateway 112 and the computing environment 106 over which client devices coupled to the branch gateway 112 are able to communicate. Bidirectional communications can occur over each underlay uplink path.

The overlay and underlay network 104 further includes an overlay network 120 that has overlay network paths 118-1, 118-2, and 118-3. Each overlay network path 118-1, 118-2, or 118-3 can be established over a respective underlay uplink path 114-1, 114-2, or 114-3. For example, an overlay network path 118-1 can be established over the underlay uplink path 114-1, an overlay network path 118-2 can be established over the underlay uplink path 114-2, and overlay network path 118-3 can be established over the underlay uplink path 114-3.

Examples of the overlay network paths 118-1 to 118-3 include Internet Protocol Security (IPSec) tunnels. An IPsec tunnel refers to a tunnel in which a data packet is encrypted and encapsulated according to the IPsec protocol, as described in various Request for Comments (RFCs), including RFC 2401, entitled “Security Architecture for the Internet Protocol,” dated November 1998. An IPsec tunnel can perform encapsulation according to the Encapsulating Security Payload (ESP) protocol, as described in RFC 4303, entitled “IP Encapsulating Security Payload (ESP),” dated December 2005.

In other examples, the overlay network paths 118-1 to 118-3 can operate according to other protocols.

Collectively, an underlay uplink path and a corresponding overlay network path established over the underlay uplink path is referred to as an “overlay and underlay path,” which is a communication path through the overlay and underlay network 104. Although FIG. 1 shows three overlay and underlay paths between the branch computing location 102 and the computing environment 106, in other examples, less than three or more than three overlay and underlay paths may be provided between the branch computing location 102 and the computing environment 106.

The branch gateway 112 includes multiple network stacks that connect to respective overlay and underlay paths. A first network stack includes an underlay network stack (UNS) 122-1 that supports communications over the underlay uplink path 114-1, and an overlay network stack (OVS) 123-1 that supports communications over the overlay network path 118-1. A second network stack includes an underlay network stack 122-2 that supports communications over the underlay uplink path 114-2, and an overlay network stack 123-2 that supports communications over the overlay network path 118-2. A third network stack includes an underlay network stack 122-3 that supports communications over the underlay uplink path 114-3, and an overlay network stack 123-3 that supports communications over the overlay network path 118-3.

An underlay network stack 122-1, 122-2, or 122-3 has various layers, including layer 1 (a physical layer), layer 2 (e.g., a link layer that includes a MAC layers), layer 3 (e.g., an IP layer), and layer 4 (e.g., a TCP layer or a UDP layer). In other examples, an underlay network stack can include additional or alternative layers.

An overlay network stack 123-1, 123-2, or 123-3 has various layers, including a route layer (e.g., a layer that supports IP routes), a security tunnel layer (e.g., an IPSec layer), and layer 4 (e.g., a TCP layer or a UDP layer). In other examples, an overlay network stack can include additional or alternative layers.

The computing environment 106 similarly includes multiple network stacks that connect to respective overlay and underlay paths. A first network stack of the computing environment 106 includes an underlay network stack (UNS) 152-1 that supports communications over the underlay uplink path 114-1, and an overlay network stack (OVS) 153-1 that supports communications over the overlay network path 118-1. A second network stack of the computing environment 106 includes an underlay network stack 152-2 that supports communications over the underlay uplink path 114-2, and an overlay network stack 153-2 that supports communications over the overlay network path 118-2. A third network stack of the computing environment 106 includes an underlay network stack 152-3 that supports communications over the underlay uplink path 114-3, and an overlay network stack 153-3 that supports communications over the overlay network path 118-3.

In accordance with some examples of the present disclosure, the computing environment 106 includes a network outage predictor 130, which can be implemented using one or more computers. In other examples, the network outage predictor 130 can be outside the computing environment 106, and in fact, may be able to support prediction of faults associated with overlay and underlay networks coupled to respective different computing environments.

The network outage predictor 130 includes a fault detection machine learning (ML) models 132-1, 132-2, and 132-3, and embedding generation ML models 134-1, 134-2, and 134-3. The fault detection ML model 132-1 is used to predict communication-related faults associated with access of services provided by the computing environment 106 over a first overlay and underlay path (that includes the underlay uplink path 114-1 and the overlay network path 118-1), the fault detection ML model 132-2 is used to predict communication-related faults associated with access of services provided by the computing environment 106 over a second overlay and underlay path (that includes the underlay uplink path 114-2 and the overlay network path 118-2), and the fault detection ML model 132-3 is used to predict communication-related faults associated with access of services provided by the computing environment 106 over a third overlay and underlay path (that includes the underlay uplink path 114-3 and the overlay network path 118-3).

The embedding generation ML model 134-1 can generate an embedding vector 140-1 of attributes based on an input collection 138-1 of attributes provided from a data collector 136-1, the embedding generation ML model 134-2 can generate an embedding vector 140-2 of attributes based on an input collection 138-2 of attributes provided from a data collector 136-2, and the embedding generation ML model 134-3 can generate an embedding vector 140-3 of attributes based on an input collection 138-3 of attributes provided from a data collector 136-3.

The data collectors 136-1, 136-2, and 136-3 can be implemented using one or more computers. In other examples, the data collectors 136-1, 136-2, and 136-3 can be part of the network outage predictor 130.

In FIG. 1, there is one data collector, one embedding generation ML model, and one fault detection ML model provided per network stack. In other examples, a data collector, an embedding generation ML model, and a fault detection ML model can be used with multiple network stacks.

An example of an ML model included in a fault detection ML model or an embedding generation ML model can include a neural network, such as an artificial neural network (ANN) or a deep neural network (DNN). In other examples, other types of ML models can be used in a fault detection ML model or an embedding generation ML model.

A data collector 136-j (j=1 to 3) can collect attributes associated with various layers, including an application layer that contains the application program 110 or any other resource that provides a service, the overlay network 120, and the underlay network 116. The data collector 136-j is able to collect attributes associated with communication-related operations, including communications over the overlay and underlay network 104 and operations of the service provided by the computing environment 106.

An input collection 138-j of attributes is a high-dimensional representation of values associated with the attributes. The embedding generation ML model 134-j generates, based on the input collection 138-j of attributes, the embedding vector 140-j, which is provided as an input to the fault detection ML model 132-j.

The embedding vector 140-j contains an N-dimensional collection of attributes (N>1) where N is less than the quantity of dimensions present in a high-dimensional input collection 138-j of attributes.

### Example Attributes

The following are examples of attributes associated with the underlay network 116. Although various example attributes are listed in the tables below, it is noted that in other examples, different or additional attributes may be employed, and some of the attributes may be omitted. The underlay network attributes are part of an input collection 138-j (j=1 to 3) of attributes obtained by a respective data collector 136-j and provided to a corresponding embedding generation ML model 134-j.

Table 1 lists example attributes of layer 2 of the underlay network 116.

TABLE 1

| | | | | T1 | T2 | T3 |
|---|---|---|---|---|---|---|
| | T1 | T2 | T3 | (Normalized) | (Normalized) | (Normalized) |
| Number of link | 22 | 32 | 25 | 0.433333 | −0.56667 | 0.133333333 |
| layer collisions | | | | | | |
| Number of ink | 45 | 64 | 53 | 0.473684 | −0.52632 | 0.052631579 |
| layer errors | | | | | | |
| Number of out-of- | 66 | 103 | 84 | 0.495495 | −0.5045 | 0.009009009 |
| order data frames | | | | | | |
| Average jitter | 20 | 54 | 33 | 0.460784 | −0.53922 | 0.078431373 |
| (milliseconds) | | | | | | |
| Average | 50 | 85 | 73 | 0.552381 | −0.44762 | −0.1047619 |
| response time | | | | | | |
| (milliseconds) | | | | | | |
| Average | 465 | 654 | 546 | 0.47619 | −0.52381 | 0.047619048 |
| bandwidth | | | | | | |
| utilization | | | | | | |
| (megabits per | | | | | | |
| second) | | | | | | |
| Link L2 health | 0.8 | 0.96 | 0.9 | −0.54167 | 0.458333 | 0.083333333 |
| factor | | | | | | |

In Table 1, various attributes are represented as rows in the table, including a number of link layer collisions (a count of how many times multiple network devices transmit at the same time on the same network segment), a number of link layer errors (a count of how many errors occur in the link layer), a number of out-of-order data frames (a count of how many link layer data frames, which are data packets of the link layer, are communicated out of order), an average jitter (jitter refers to a variance in latency in a network segment), average response time (a response time refers to how long a recipient device responds to a source device), average bandwidth utilization (a bandwidth utilization refers to how much bandwidth is consumed in a network segment), and a link layer health factor (which is a parameter representing the health of a network segment).

Table 1 lists the values of respective attributes in the T1, T2, and T3 columns, which represent different time points. Although just three time points are depicted in Table 1, note that there may be many more time points in an actual example. Table 1 also lists normalized values of the attributes at the T1, T2, and T3 time points, in the T1 (normalized), T2 (normalized), and T3 (normalized) columns of Table 1. A normalized value of an attribute falls in a specified range, such as between 0 and 1.

In some examples, normalized values are calculated using Eq. 1 below.

$${{σ}_{current} ( m ( x ) )}_{Normalized} = \frac{{σ}_{avg} ( m ( x ) ) - {σ}_{current} ( m ( x ) )}{{σ}_{max} ( m ( x ) ) - {σ}_{min} ( m ( x ) )} . \qquad ( Eq . 1 )$$

In Eq. 1, σ_{avg}(m(x)) is the average value of an attribute, m(x), σ_{current}(m(x)) is a current value of the attribute, σₘₐₓ(m(x)) is the maximum value of the attribute, and σₘᵢₙ(m(x)) is the minimum value of the attribute. The normalized attribute value, at a given time point (e.g., one of T1, T2, or T3) is σ_{current}(m(x))_{Normalized}.

Table 2 lists examples of attributes of layer 3 of the underlay network 116.

TABLE 2

| | | | | T1 | T2 | T3 |
|---|---|---|---|---|---|---|
| | T1 | T2 | T3 | (Normalized) | (Normalized) | (Normalized) |
| System-wide total routes | 100 | 80 | 124 | −0.0303 | −0.48485 | 0.515152 |
| System-wide route adds | 20 | 30 | 35 | −0.55556 | 0.111111 | 0.444444 |
| System-wide route deletes | 5 | 25 | 3 | −0.27273 | 0.636364 | −0.36364 |
| A number of out-of-order IP | 10 | 15 | 29 | −0.42105 | −0.15789 | 0.578947 |
| data packets | | | | | | |
| Number of OSPF link state | 50 | 40 | 34 | 0.541667 | −0.08333 | −0.45833 |
| requests | | | | | | |
| Number of OSPF link state | 30 | 33 | 18 | 0.2 | 0.4 | −0.6 |
| updates | | | | | | |
| L3 link health metric | 0.8 | 0.9 | 0.5 | 0.166667 | 0.416667 | −0.58333 |

In Table 2, various attributes are represented as rows in the table, including system-wide total routes (which represents how many total layer 3 routes (e.g., IP routes) are in a system, system-wide route adds (which represents how many layer 3 routes have been added), system-wide route deletes (which represents how many layer 3 routes have been deleted), a number of out-of-order IP packets, a number of OSPF (Open Shortest Path First) link state requests (OSPF is part of an example IP routing protocol), a number of OSPF link state updates, and a layer 3 link health metric.

Examples of additional layer 3 attributes of the underlay network 116 include a number of OSPF link state acknowledgements, a number of OSPF VLAN (virtual local area network) packets out, a number of OSPF VLAN packets in, a number of OSPF VLAN total routes, a number of OSPF VLAN route adds, a number of OSPF VLAN route deletes, a number of BGP (Border Gateway Protocol) open, update, notification, keep-alive, and/or route refresh messages, a number of BGP route updates in/out (received/invalid/filtered/ignored/accepted), and a BGP connection state.

Table 2 lists the values of respective attributes in the T1, T2, and T3 columns, which represent different time points. Table 2 also lists normalized values of the attributes at the T1, T2, and T3 time points, in the T1 (normalized), T2 (normalized), and T3 (normalized) columns of Table 2. A normalized value of an attribute falls in a specified range, such as between 0 and 1.

Examples of attributes of layer 4 of the underlay network 116 can include a number of TCP retransmits (a count of how many times TCP retransmits occur in a network segment, a number of TCP timeouts (a count of how many times TCP in a network segment, a number of TCP out-of-order data packets, TCP receiver window sizes, and sender congestion window sizes. The above attributes of layer 4 of the underlay network 116 may be provided at respective time points, and may be normalized at the respective time points in a manner similar to the normalization depicted in Table 1 or 2.

Examples of attributes of an application layer (e.g., a layer including an entity that provides a service of the computing environment 106) can include a number of successful session establishments (a count of how many times sessions are established), a number of failed session establishments (a count of how many times sessions establishment failures occurred), a number of blocked sessions (a count of how many times sessions are blocked), a number of aborted sessions (a count of how many times sessions are aborted).

The above attributes of the application layer may be provided at respective time points, and may be normalized at the respective time points in a manner similar to the normalization depicted in Table 1 or 2.

The following refers to examples of attributes of layers of the overlay network 120. Examples of attributes of a route layer of the overlay network 120 can include a number of ORO (overlay route orchestrator) route adds (a count of how many routes, such as IP routes, have been added by the ORO, where the ORO is a program that is responsible for establishing routes between the computing environment 106 and a branch computing location), a number of ORO route deletes (a count of how many routes have been deleted by the ORO), a number of ORO route updates (a count of how many routes have been updated by the ORO), and a number of ORO topology change notifications (a count of how many times the ORO has sent notifications to change a route topology).

The above attributes of the route layer of the overlay network 120 may be provided at respective time points, and may be normalized at the respective time points in a manner similar to the normalization depicted in Table 1 or 2.

Examples of attributes of an IPSec layer of the overlay network 120 can include a number of DPD (dead peer detection) initiate requests (dropped) (a count of how many times initiate requests according to the DPD protocol are dropped, where DPD refers to a protocol for detecting unreachable Internet Key Exchange (IKE) peers), a number of DPD initiate requests (re-sent) (a count of how many times initiate requests according to the DPD protocol are re-sent), a number of DPD responder requests (dropped) (a count of how many times requests from responders to DPD requests are dropped), and a number of times DPD peers are detected as dead.

The overlay network 120 may also include layer 4. Examples of attributes of layer 4 of the overlay network 120 are similar to the attributes of layer 4 of the underlay network 116 discussed above.

### Fault Detection

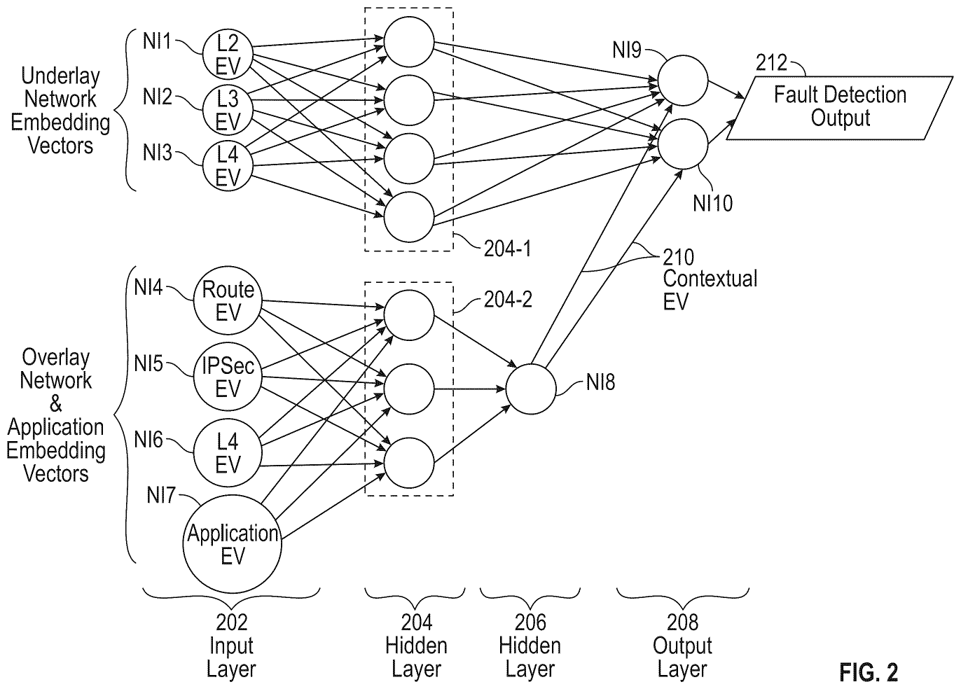

As noted above, in some examples, a fault detection ML model 132-j (j=1 to 3) can include a neural network, such as an ANN or DNN. FIG. 2 shows an example of a neural network 200 for implementing the fault detection ML model 132-j, according to some examples. A neural network includes an input layer, one or more hidden layers, and an output layer. Each of the layers include artificial neurons, and the artificial neurons of the layers are interconnected. In the example of FIG. 2, the neural network 200 includes an input layer 202, two hidden layers 204 and 206, and an output layer 208. In other examples, the neural network 200 can include a different quantity of hidden layers.

Also, although FIG. 2 shows each layer with a specific quantity of nodes (artificial neurons), in other examples, a different quantity of nodes can be included in any of the layers of the neural network 200.

Each node, or artificial neuron, connects to another and has an associated weight and bias (also referred to as a threshold). If the output produced by an activation function (a linear function or a nonlinear function) of any individual node is above the specified threshold (bias), that node is activated, sending data to the next layer of the neural network. Otherwise, data is not passed to the next layer of the network.

Each node of a hidden layer (204 or 206) receives an input from a node of a previous layer (either the input layer 202 or a previous hidden layer 204) and similarly produces an output based on application of an activation function. The output is compared by the node in the hidden layer (204 or 206) to a respective bias to determine whether the node in the hidden layer (204 or 206) is to be activated to pass data to the next layer (either another hidden layer 206 or the output layer 208).

The output layer 208 of the neural network 200 can apply a softmax activation function in some examples. “Softmax” refers to a function that converts a vector of values (e.g., from a hidden layer) into a vector of probabilities. The output layer 208 of the neural network can produce M values (M≥1), one for each layer of the application layer, the underlay network 116, and the overlay network 118. A value of the M values represents a probability that a respective layer of the application layer, the underlay network 116, and the overlay network 118 is experiencing a fault.

The softmax activation function normalizes output values from the previous hidden layer and converts such values into probabilities that sum to 1. Each value in the output of the softmax activation function for the output layer 208 is interpreted as the probability of membership for each label.

The input layer 202 of the neural network 200 includes a node NI1 representing an underlay network L2 embedding vector, a node NI2 representing an underlay network L3 embedding vector, and a node NI3 representing an underlay network L4 embedding vector. The underlay network L2 embedding vector is generated by an embedding generation ML model 134-j based on layer 2 attributes of the underlay network 116 (included in the respective input collection 138-j of attributes). The underlay network L3 embedding vector is generated by the embedding generation ML model 134-j based on layer 3 attributes of the underlay network 116 (included in the respective input collection 138-j of attributes). The underlay network L4 embedding vector is generated by the embedding generation ML model 134-j based on layer 4 attributes of the underlay network 116 (included in the respective input collection 138-j of attributes).

The input layer 202 of the neural network 200 further includes a node NI4 representing an overlay network route embedding vector (EV), a node NI5 representing an overlay network IPSec embedding vector, and a node NI6 representing an overlay network L4 embedding vector. The overlay network route embedding vector is generated by the embedding generation ML model 134-j based attributes of a route layer of the overlay network 120 (included in the respective input collection 138-j of attributes). The overlay network IPSec embedding vector is generated by the embedding generation ML model 134-j based on attributes of the IPSec layer of the overlay network 120 (included in the respective input collection 138-j of attributes). The overlay network L4 embedding vector is generated by the embedding generation ML model 134-j based on layer 4 attributes of the overlay network 120 (included in the respective input collection 138-j of attributes).

The input layer 202 of the neural network 200 further includes a node NI7 that represents an application layer embedding vector, which is generated by the embedding generation ML model 134-j based on attributes of the application layer (included in the respective input collection 138-j of attributes).

Nodes in a first portion 204-1 of the hidden layer 204 of the neural network 200 receive the underlay network L2 embedding vector, the underlay network L3 embedding vector, and the underlay network L4 embedding vector. Each node in the first portion 204-1 of the hidden layer 204 produces an output based on application of an activation function of the node. The outputs from the nodes of the first portion 204-1 of the hidden layer 204 are provided as inputs to nodes NI9 and NI10 of the output layer 208.

Nodes in a second portion 204-2 of the hidden layer 204 of the neural network 200 receive the overlay network route embedding vector, the overlay network IPSec embedding vector, the overlay network L4 embedding vector, and the application layer embedding vector. Each node in the second portion 204-2 of the hidden layer 204 produces an output based on application of an activation function of the node. The outputs from the nodes of the second portion 204-2 of the hidden layer 204 are provided as inputs to a node NI8 of the hidden layer 206. Based on the inputs from the nodes of the second portion 204-2 of the hidden layer 204, the node NI8 of the hidden layer 206 produces a contextual embedding vector 210.

The contextual embedding vector 210 provides information indicating likelihoods of faults occurring in the overlay network 120 or the application layer. Note that if a fault occurs in an overlay network 120 or in the application layer, a corresponding fault would also appear in the underlay network 116. By providing the contextual embedding vector 210 to the nodes of the output layer 208, the output layer 208 can distinguish between faults caused by the overlay network 120 and/or the application layer, and faults arising from the underlay network 116. If a fault is present in the underlay network 116 but a corresponding fault is not indicated in the contextual embedding vector 210, then the output layer 208 can provide an output indicating the probability of a fault in a layer of the underlay network 116. In contrast, if a fault in the underlay network 116 is caused by a corresponding fault in the overlay network 120 or the application layer, the output layer 208 can provide an output indicating the probability of a fault in a layer of the overlay network 120 or the application layer, rather than in the underlay network 116.

The output layer 208 of the neural network 200 provides a fault detection output 212 that includes a global outage indicator and a suspect layer indicator. The global outage indicator can include an indication (e.g., a probability) of presence of a fault in the overall system, including the computing environment 106 and the overlay and underlay network 104. The suspect layer indicator can include an indication (e.g., a probability) of presence of a fault in a suspect layer (one or more layers of the underlay network 116, the overlay network 120, and the application layer that is predicted to have experienced a fault).

The neural network 200 is trained to make predictions regarding likelihood of faults. In some examples, for training the neural network 200, the neural network 200 includes an Adam optimizer, which applies an optimization algorithm for updating weights and biases of the nodes of the neural network 200 based on training data, such as labeled feature vectors, which can include labeled embedding vectors. The Adam optimizer applies a type of stochastic gradient descent optimization for learning a neural network. In other examples, other techniques of training the neural network 200 can be employed.

In some examples, the Adam optimizer uses categorical cross-entropy loss function that computes a loss associated with a prediction performed by the neural network 200. In other examples, other types of loss functions can be employed. The Adam 310 attempts to minimize (or reduce) the loss computed by the loss function during training of the neural network 200.

In some examples, the neural network 200 can be trained over multiple iterations. After the neural network 200 is trained in a first iteration, the loss function computes a loss for a prediction produced by the neural network 200. If the loss exceeds a loss threshold, then another training iteration is performed, and after the neural network 200 is trained in the next iteration, the loss function computes a loss for a prediction produced by the neural network 200. This loss is again compared to the loss threshold. The training iterates until a loss computed for a current iteration is less than the loss threshold, at which point the training can stop and the trained neural network 200 can be used to provide predictions to select file systems for workloads.

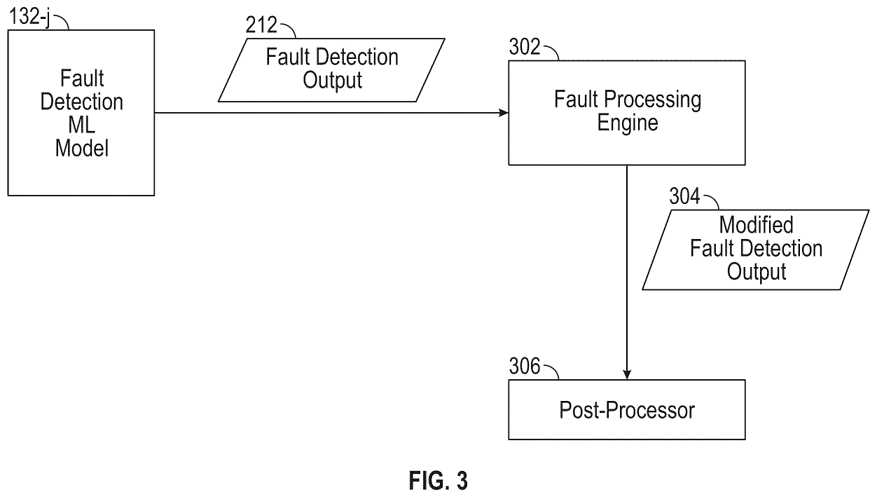

FIG. 3 is a block diagram of an example arrangement that includes a fault detection ML model 132-j and a fault processing engine 302. As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits. In some examples, the fault processing engine 302 may include an application program.

The fault processing engine 302 may implement an algorithm that provides an explanation of predictions made by an ML model, such as the fault detection ML model 132-j. Examples of algorithms that can be implemented by the fault processing engine 302 include a SHapley Additive explanations (SHAP) algorithm, a local interpretable model-agnostic explanations (LIME) algorithm, a Grad-CAM (CAM stands for class activation mapping) algorithm, or any other algorithm that seeks to explain how the ML model generates its predictions. For example, the LIME algorithm varies (“perturbs”) the values in the input embedding vectors used by the fault detection ML model 132-j to determine how the perturbed (varied) input embedding vectors modifies predictions made by the fault detection ML model 132-j. The SHAP algorithm uses random feature combinations (combinations of the input embedding vectors) as input and determines the changes in the performance the fault detection ML model 132-j. The Grad-CAM algorithm uses the gradient of a classification score with respect to the convolutional features determined by the fault detection ML model 132-j to understand which parts of the input embedding vectors are most important for predictions of the fault detection ML model 132-j.

The fault processing engine 302 is used to further process the fault detection output 212 to check for any inaccuracies in the fault detection ML model 132-j. The fault processing engine 302 is used to confirm that a prediction made by the fault detection ML model 132-j is accurate. If the fault processing engine 302 determines that a prediction made by the fault detection ML model 132-j is inaccurate, the fault processing engine 302 can output an error indication, or alternatively, may produce a modified version of the fault detection output 212, such as by changing the indicator of which layer of the underlay network 116, the overlay network 120, and the application layer is the actual suspect layer experiencing the fault. The modified version of the fault detection output 212 is represented as a modified fault detection output 304 in FIG. 3.

In some examples, the fault detection output 212 can be computed using an objective function of the fault detection ML model 132-j, where the objective function calculates the individual class probabilities outage function vector at inference time (time of applying the fault detection ML model 132-j to the input embedding vectors). The individual class probabilities outage function vector, which is an example of the fault detection output 212, includes a vector of probabilities representing respective likelihoods of faults occurring in respective layers of the underlay network 116, the overlay network 120, and the application layer. Each probability in the probabilities outage function vector can be referred to as a “contribution parameter” to indicate the likelihood that a respective layer of underlay network 116, the overlay network 120, and the application layer contributed to a fault.

As further shown in FIG. 3, the fault processing engine 302 can provide the modified fault detection output 304 to a post-processor 306, which can be implemented using one or more computers. Alternatively, the fault detection ML model 132-j can provide the fault detection output 212 to the post-processor 306. The post-processor 306 can apply further processing to understand the indicated faults (and causes of those faults). The indicated faults are the faults in one or more suspect layers indicated by the modified fault detection output 304.

In some examples, the post-processor 306 can generate probabilistic thresholds of contribution parameters based on a baseline model. As noted above, a contribution parameter can represent a likelihood of a respective layer of the underlay network 116, the overlay network 120, and the application layer contributing to a fault. The baseline model generates a baseline value (a probabilistic threshold) of a contribution parameter using a baselining algorithm. In some examples, the baselining algorithm may be based on one or more factors, such as any or some combination of the following: a mean value, a median value, a most frequent value, a maximum value, or a one-class support vector machine (SVM). The baselining algorithm may use values observed over a period for the contribution parameter. Once a probabilistic threshold is computed for each contribution parameter, the post-processor 306 can compare the value of each contribution parameter to the respective probabilistic threshold to further evaluate whether an indicated fault (as indicated by the fault detection output 212 or the modified fault detection output 304) actually represents an anomaly that should be addressed with a remediation action. Examples of remediation actions can include reconfiguring a network stack, updating a network stack or a program, disabling a network stack or a program, disabling a hardware component, rebooting a device, or any other remediation action.

In further examples, the post-processor 306 can additionally or alternatively compare contributions of different layers of the underlay network 116, the overlay network 120, and the application layer to a given fault. The contributions of the different layers can be compared by comparing the values of the contribution parameters, such as in the fault detection output 212 or the modified fault detection output 304. Comparing the values of the contribution parameters can allow for a better understanding of how interactions of different layers may have contributed to the given fault.

Based on various analyses of the post-processor 306, such as those discussed above, the post-processor 306 can identify a root cause of a fault.

### Embedding Vectors Generation

An embedding generation ML model 134-j (j=1 to 3) can also include a neural network, such as an ANN or DNN. The input to the embedding generation ML model 134-j is the respective input collection 138-j of attributes. In some examples, the input collection 138-j of attributes includes normalized values (using normalization according to Eq. 1, for example). The embedding generation ML model 134-j is trained to generate embedding vectors based on input attributes of layers of the underlay network 116, the overlay network 120, and the application layer.

### FURTHER EXAMPLES

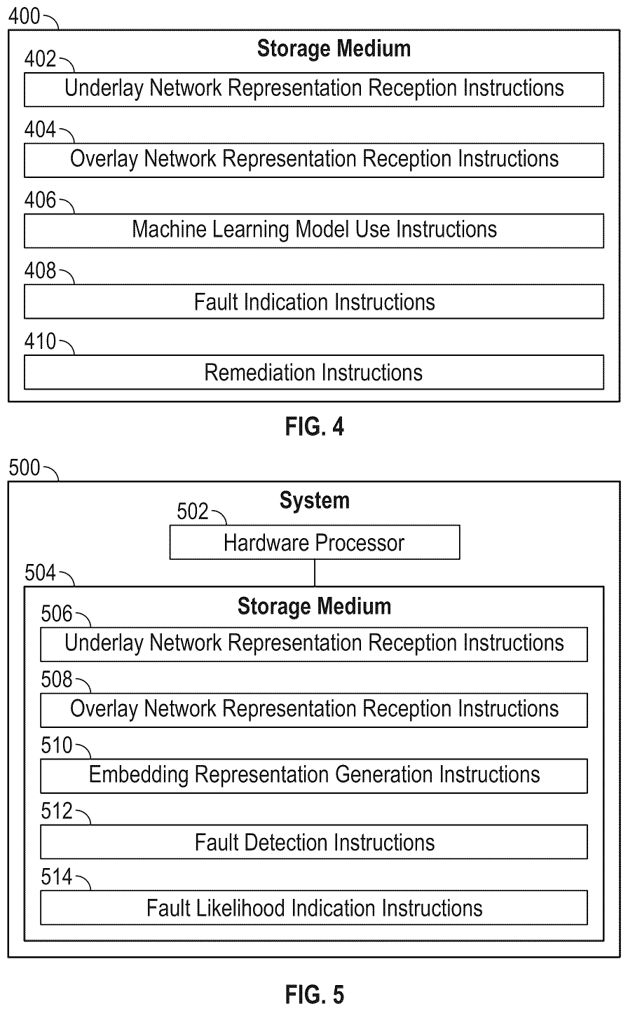

FIG. 4 is a block diagram of a non-transitory machine-readable or computer-readable storage medium 400 storing machine-readable instructions that upon execution cause a computer system to perform various tasks. The computer system may include the network outage predictor 130 of FIG. 1, for example, and further may include the fault processing engine 302 and/or the post-processor 306 of FIG. 3.

The machine-readable instructions include underlay network representation reception instructions 402 to receive a first representation of attributes associated with a network stack connected to an underlay network that couples a first system to a computing environment, where the network stack includes a plurality of layers. An example of the first system is the branch computing location 102 or the branch gateway 112 of FIG. 1. An example of the computing environment is the computing environment 106 of FIG. 1. An example of the network stack connected to the underlay network includes an underlay network stack (e.g., any of 123-1 to 123-3 and 153-1 to 153-3 in FIG. 1). An example of the underlay network is the underlay network 116 of FIG. 1.

The machine-readable instructions include overlay network representation reception instructions 404 to receive a second representation of attributes associated with an overlay network provided over the underlay network. An example of the overlay network is the overlay network 120 of FIG. 1. In further examples, the second representation includes a representation of attributes associated with a service that uses the overlay network for communications, where the service can be provided by a resource of an application layer.

The machine-readable instructions include machine learning model use instructions 406 to provide the first representation and the second representation to a machine learning model trained to detect a fault associated with communications between the first system and the computing environment. An example of the machine learning model is a fault detection ML model 132-1, 132-2, or 132-3.

The machine-readable instructions include fault indication instructions 408 to generate, by the machine learning model, an output including a value representing a likelihood of a presence of the fault associated with the overlay network or the underlay network.

The machine-readable instructions include remediation instructions 410 to, based on the output, initiate a remediation action to address the fault. Examples of remediation actions can include reconfiguring a network stack, updating a network stack or a program, disabling a network stack or a program, disabling a hardware component, rebooting a device, or any other remediation action.

In some examples, the output indicates the presence of the fault in an identified layer of the plurality of layers in the network stack connected to the underlay network. The identified layer may include layer 2, layer 3, or layer 4 of the underlay network.

In some examples, the output indicates the presence of the fault in a communication path of the overlay network, where the communication path may include a route or a tunnel according to a security protocol (e.g., an IPSec tunnel).

In some examples, the first representation includes an embedding representation (e.g., an embedding vector) of the attributes associated with the network stack, and the second representation includes an embedding representation (e.g., an embedding vector) of the attributes associated with an overlay network.

In some examples, the machine-readable instructions input the attributes associated with the network stack to a further machine learning model, and the further machine learning model generates the first and second embedding representations based on the attributes.

In some examples, the second representation includes a representation of attributes associated with communication paths in the overlay network, and a representation of attributes associated with a service that uses the overlay network for communications. The machine learning model generates a contextual representation (e.g., the contextual embedding vector 210 of FIG. 2) based on the representation of the attributes associated with the communication paths in the overlay network, and the representation of the attributes associated with the service that uses the overlay network for communications. The contextual representation is input into a model layer of the machine learning model, and the model layer further receives as input predictions performed by the machine learning model based on the first representation.

In some examples, the machine learning model includes a neural network, and the model layer includes an output layer that receives the context representation and the predictions performed by the machine learning model based on the first representation.

FIG. 5 is a block diagram of a system 500, which may include one or more computers. The system 500 includes a hardware processor 502 (or multiple hardware processors). A hardware processor can include a microprocessor, a core of a multi-core microprocessor, a microcontroller, a programmable integrated circuit, a programmable gate array, or another hardware processing circuit.

The system 500 further includes a storage medium 504 storing machine-readable instructions executable on the hardware processor 502 to perform various tasks. Machine-readable instructions executable on a hardware processor can refer to the instructions executable on a single hardware processor or the instructions executable on multiple hardware processors.

The machine-readable instructions in the storage medium 504 include underlay network representation reception instructions 506 to receive a first representation of attributes associated with an underlay network stack connected to an underlay network that couples a first system to a computing environment, where the underlay network stack includes a plurality of layers.

The machine-readable instructions in the storage medium 504 include overlay network representation reception instructions 508 to receive a second representation of attributes associated with an overlay network provided over the underlay network.

The machine-readable instructions in the storage medium 504 include embedding representation generation instructions 510 to generate, using a first machine learning model, a first embedding representation of the first representation of attributes, and a second embedding representation of the first representation of attributes. The first and second embedding representations may include embedding vectors of attributes.

The machine-readable instructions in the storage medium 504 include fault detection instructions 512 that use a second machine learning model that receives the first embedding representation and the second embedding representation for detecting a fault, where the second machine learning model is trained to detect a fault associated with communications between the first system and the computing environment.

The machine-readable instructions in the storage medium 504 include fault likelihood indication instructions 514 to generate, by the second machine learning model, an output comprising a value representing a likelihood of a presence of the fault associated with the overlay network or the underlay network.

In some examples, the output generated by the second machine learning model includes contribution parameters that indicate faults in respective layers of the underlay network and layers of the overlay network.

In some examples, a contribution parameter of the contribution parameters represents a likelihood that a respective layer of the underlay network and the overlay network contributed to a fault.

In some examples, the output generated by the second machine learning model further includes a further contribution parameter that indicates a fault in an application layer of the computing environment, the application layer comprising a resource that provides a service.

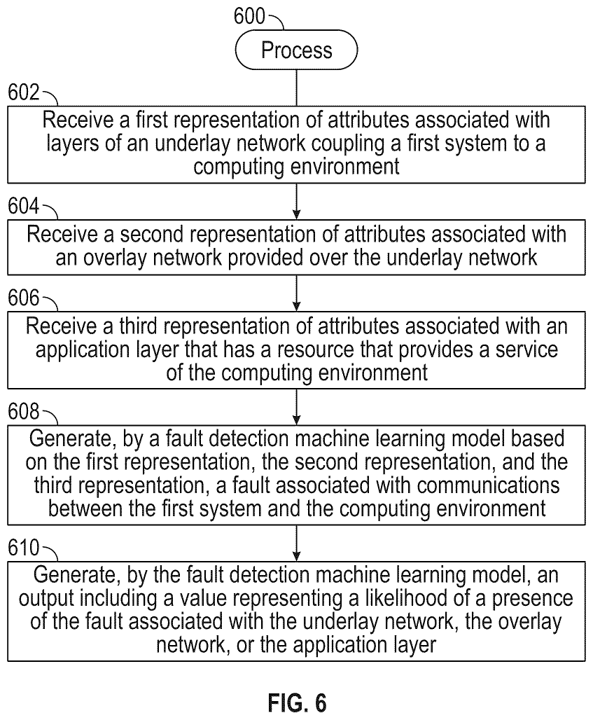

FIG. 6 is a flow diagram of a process 600 according to some examples. The process 600 can be performed by a computer system. The process 600 includes receiving (at 602) a first representation of attributes associated with layers of an underlay network coupling a first system to a computing environment. The process 600 includes receiving (at 604) a second representation of attributes associated with an overlay network provided over the underlay network. The process 600 includes receiving (at 606) a third representation of attributes associated with an application layer that has a resource that provides a service of the computing environment. The first, second, and third representations can include embedding vectors derived by an embedding generation machine learning model (e.g., 134-1, 134-2, or 134-3 in FIG. 1.

The process 600 includes generating (at 608), by a fault detection machine learning model based on the first representation, the second representation, and the third representation, a fault associated with communications between the first system and the computing environment.

The process 600 includes generating (at 610), by the fault detection machine learning model, an output including a value representing a likelihood of a presence of the fault associated with the underlay network, the overlay network, or the application layer.

In accordance with some examples of the present disclosure, proactive monitoring, fault detection, and mitigating actions can be efficiently and quickly provided using the data collectors 136-1 to 136-3 and the network outage predictor 130 of FIG. 1 in a system that may include a large number of devices. For example, there may be many branch computing locations (dispersed globally, for example) that are coupled over overlay and underlay networks to one or more computing environments. By using the network outage predictor 130, early prediction of faults can be provided, and system administrators can avoid having to spend a lot of time and effort in analyzing faults that have already occurred. By predicting faults early and taking remediation actions to address the predicted faults, users and other entities can be more productive as the likelihood of downtime is reduced.

A storage medium (e.g., 400 in FIG. 4 or 504 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a computer system to:
receive a first representation of attributes associated with a network stack connected to an underlay network that couples a first system to a computing environment, wherein the network stack comprises a plurality of layers;
receive a second representation of attributes associated with an overlay network provided over the underlay network;
provide the first representation and the second representation to a machine learning model trained to detect a fault associated with communications between the first system and the computing environment;
generate, by the machine learning model, an output comprising a value representing a likelihood of a presence of the fault associated with the overlay network or the underlay network; and
based on the output, initiate a remediation action to address the fault.

2. The non-transitory machine-readable storage medium of claim 1, wherein the output indicates the presence of the fault in an identified layer of the plurality of layers in the network stack connected to the underlay network.

3. The non-transitory machine-readable storage medium of claim 1, wherein the output indicates the presence of the fault in a communication path of the overlay network.

4. The non-transitory machine-readable storage medium of claim 1, wherein the first representation comprises an embedding representation of the attributes associated with the network stack.

5. The non-transitory machine-readable storage medium of claim 4, wherein the instructions upon execution cause the computer system to:
input the attributes associated with the network stack to a model; and
generate, by the model, the embedding representation based on the attributes.

6. The non-transitory machine-readable storage medium of claim 5, wherein the model comprises a machine learning model.

7. The non-transitory machine-readable storage medium of claim 1, wherein the first representation comprises a representation of attributes of a first layer of the network stack, and a representation of attributes of a second layer of the network stack.

8. The non-transitory machine-readable storage medium of claim 1, wherein the second representation comprises a representation of attributes associated with routes in the overlay network.

9. The non-transitory machine-readable storage medium of claim 1, wherein the second representation comprises a representation of attributes associated with a tunnel according to a security protocol in the overlay network.

10. The non-transitory machine-readable storage medium of claim 1, wherein the second representation comprises a representation of attributes associated with a service that uses the overlay network for communications.

11. The non-transitory machine-readable storage medium of claim 1, wherein the second representation comprises a representation of attributes associated with communication paths in the overlay network, and a representation of attributes associated with a service that uses the overlay network for communications, and
wherein the machine learning model is to:
generate a contextual representation based on the representation of the attributes associated with the communication paths in the overlay network, and the representation of the attributes associated with the service that uses the overlay network for communications, and
input the contextual representation into a model layer of the machine learning model, the model layer further receiving as input predictions performed by the machine learning model based on the first representation.

12. The non-transitory machine-readable storage medium of claim 11, wherein the machine learning model comprises a neural network, and the model layer comprises an output layer that receives the context representation and the predictions performed by the machine learning model based on the first representation.

13. The non-transitory machine-readable storage medium of claim 1, wherein the underlay network includes a plurality of network paths to the computing environment, the plurality of network paths comprising a first network path and a second network path, wherein the machine learning model is for the first network path and the overlay network is established over the first network path, and wherein the instructions upon execution cause the computer system to:
use a different machine learning model to predict a fault associated with the second network path and another overlay network established over the second network path.

14. A system comprising:
a hardware processor; and
a non-transitory storage medium storing machine-readable instructions executable on the hardware processor to:
receive a first representation of attributes associated with an underlay network stack connected to an underlay network that couples a first system to a computing environment, wherein the underlay network stack comprises a plurality of layers;
receive a second representation of attributes associated with an overlay network provided over the underlay network;
generate, using a first machine learning model, a first embedding representation of the first representation of attributes, and a second embedding representation of the first representation of attributes;
provide the first embedding representation and the second embedding representation to a second machine learning model trained to detect a fault associated with communications between the first system and the computing environment; and
generate, by the second machine learning model, an output comprising a value representing a likelihood of a presence of the fault associated with the overlay network or the underlay network.

15. The system of claim 14, wherein the output generated by the second machine learning model comprises contribution parameters that indicate faults in respective layers of the underlay network and layers of the overlay network.

16. The system of claim 15, wherein a contribution parameter of the contribution parameters represents a likelihood that a respective layer of the underlay network and the overlay network contributed to a fault.

17. The system of claim 15, wherein the output generated by the second machine learning model further comprises a further contribution parameter that indicates a fault in an application layer of the computing environment, the application layer comprising a resource that provides a service.

18. The system of claim 14, wherein the second machine learning model includes a neural network comprising:
a first collection of nodes to receive the first embedding representation,
a second collection of nodes to receive the second embedding representation, and
a third collection of nodes to receive as inputs a first result derived by the first collection of nodes based on the first embedding representation, and a second result derived by the second collection of nodes based on the second embedding representation.

19. A method comprising:
receiving, by a system comprising a hardware processor, a first representation of attributes associated with layers of an underlay network coupling a first system to a computing environment;
receiving a second representation of attributes associated with an overlay network provided over the underlay network;
receiving a third representation of attributes associated with an application layer comprising a resource that provides a service of the computing environment;
generating, by a machine learning model based on the first representation, the second representation, and the third representation, a fault associated with communications between the first system and the computing environment; and
generating, by the machine learning model, an output comprising a value representing a likelihood of a presence of the fault associated with the underlay network, the overlay network, or the application layer.

20. The method of claim 19, wherein the first representation comprises a first embedding vector of the attributes associated with the layers of the underlay network, a second embedding vector of the attributes associated with the layers of the overlay network, and a third embedding vector of the attributes associated with the application layer.
